(19) United States
(12) Patent Application Publication
(10) Pub. No.: US 2020/0398545 A1
(43) Pub. Date: Dec. 24, 2020

(54) LAMINATED PAPER STRUCTURE

(71) Applicant: WOLVERINE AUTOMOTIVE BOARD SALES, INC., Monroe, MI (US)

(72) Inventor: Matthew Edward Zerial, Grand Rapids, MI (US)

(21) Appl. No.: 16/905,129

(22) Filed: Jun. 18, 2020

Related U.S. Application Data
(60) Provisional application No. 62/863,947, filed on Jun. 20, 2019.

(51) Int. Cl. B32B 29/00; B32B 7/12; B32B 27/36; B32B 27/08; B32B 27/30

(52) U.S. Cl. CPC B32B 29/002; B32B 7/12; B32B 27/36; B32B 2307/306; B32B 27/306; B32B 2255/26; B32B 2305/022; B32B 27/08

(57) ABSTRACT

A multi-layered laminated paper structure for use as a vehicle wall comprising a first layer comprising one of a polymer, foil, foam or coating, and at least two layers comprising a ply of paper, and a coupling layer comprising an adhesive between each of first layer and the at least two layers for adhering each of the layers together.

### CROSS-REFERENCE TO RELATED APPLICATION(S)

This application claims the benefit of U.S. Provisional Patent Application No. 62/863,947, filed Jun. 20, 2019, which is incorporated herein by reference in its entirety.

### BACKGROUND

Outdoor structures and recreational vehicles typically utilize laminated structures or walls for a variety of purposes such as waterproofing, strengthening, reducing weight, or the like. Such laminated walls can be subjected to changing weather conditions such as wind, precipitation, and temperature shifts. Under prolonged exposure to such conditions the lamination layers can shift or otherwise undergo undesirable changes. In an example of laminated structures utilized in a vehicle, they can be subjected to additional stresses associated with movement of the vehicle.

### BRIEF DESCRIPTION

In one aspect, a multi-layered laminated paper structure for use as a vehicle wall comprises a first layer comprising one of a polyethylene terephthalate, polypropylene, aluminum foil, foam or heat resistant coating, and at least two layers comprising a ply of paper, and an adhesive layer comprising an adhesive between each of first layer and the at least two layers for adhering each of the layers together.

In another aspect, a multi-layered laminated paper structure for use as an RV wall comprises a first layer comprising a polyethylene terephthalate film, a second layer comprising a first ply of uncoated recycled chipboard, and a low-density polyethylene adhesive adhering the first layer to the second layer.

In yet another aspect, a vehicle comprising at least one side wall comprising, a fiber-glass reinforced panel, a multi-layered laminated paper structure adhered to the aluminum frame, the multi-layered laminated paper structure comprising a first layer comprising one of a polyethylene terephthalate, polypropylene, aluminum foil, foam or heat resistant coating, and at least two layers comprising a ply of paper, and an adhesive layer comprising an adhesive between each of first layer and the at least two layers for adhering each of the layers together.

### BRIEF DESCRIPTION OF THE DRAWINGS

In the drawings:

FIG. 1 is a perspective view of an example of an entire recreational vehicle sidewall according to the prior art shown with Lauan panels having seams, inked text and defects, and some portions removed for clarity.

FIG. 2 is a cross-sectional view of a typical wall panel according to the prior art.

FIG. 3 is a cross-sectional view of a laminated paper structure in accordance with various aspects described herein.

FIG. 4 is a cross-sectional view of a wall panel that includes the laminated paper structure of FIG. 3.

FIG. 5 is a list of possible combinations of materials in the various positions of the laminated paper structure of FIG. 3, consisting of materials listed in the legend.

### DETAILED DESCRIPTION

Aspects of the disclosure broadly relate to a laminated structure or substrate having one or more plies in the form of foils, laminated foils, films, scrims, foams, woven or nonwoven materials, or the like. For the purposes of illustration, the laminated structure or substrate will be described in the exemplary environment of a laminated wall in a recreational vehicle. The disclosure is not so limited, and aspects of the disclosure can have general applicability in a variety of environments, including an indoor or outdoor environment, as well as in other vehicles such as land-based, air-based, or marine applications. Aspects of the disclosure can also have broad applicability in indoor or outdoor stationary environments including building interiors, building exteriors, sheds, basement structures, or the like.

As used herein, all directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of the disclosure. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

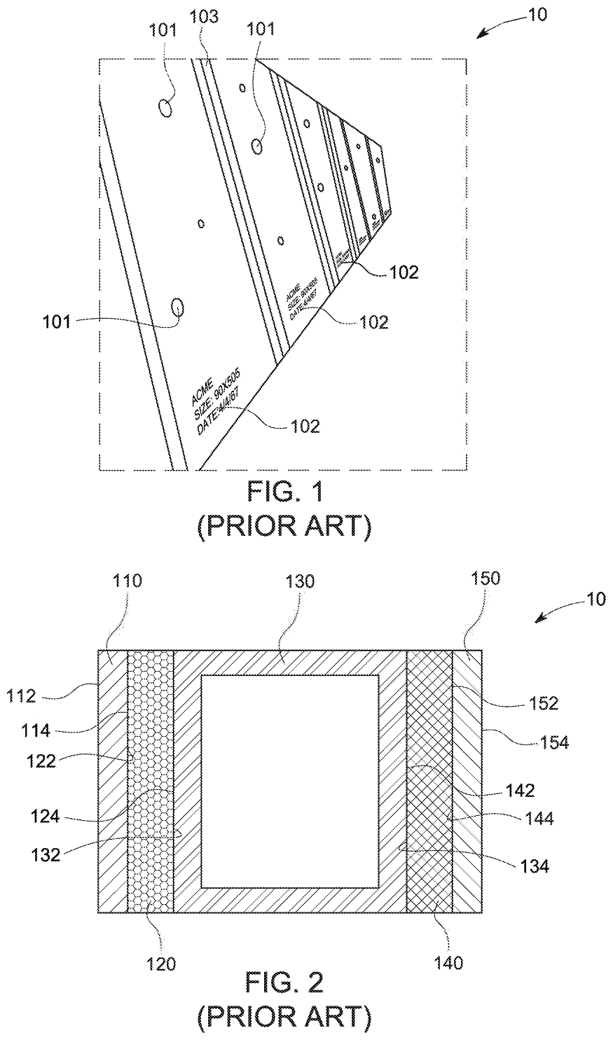

Referring to FIG. 1, contemporary recreational vehicles typically include a laminated Lauan plywood panel wall 10. The plies of a Lauan plywood panel in a recreational vehicle wall 10 can have differing material properties or natural features. For example, plies from different Lauan species can contract or expand to different degrees when subjected to environmental conditions or motion stresses, shortening the lifetime of the laminated structure. As illustrated in FIG. 1, the surface of the Lauan plywood panels (120, 140) in an RV wall panel of the prior art typically has blemishes 101, including knot holes, and manufacturer markings 102, including textual information such as size or date of manufacture. Areas of the Lauan plywood panels (120, 140) with these blemishes 101 and markings 102 do not bond well to adjacent layers and thus are generally filled with epoxy to ensure a good bond site. Likewise, the seams 103 where the wall panels meet form voids that are repaired using fiberglass scrims and epoxy. Furthermore, the use of dyes or other agents on the panel walls can alter the material properties of the panel wall. In a non-limiting example, dark-colored regions can increase the heat transfer causing unattractive and undesirable blemishes such as warping, blistering, bubbling, cracking, peeling, delamination, or the like, as is generally known in the art. Recreational vehicle wall panels 10 typically have exterior fiberglass reinforced, gel-coated panels (FRP) or FRP skins that are laminated to a Lauan plywood panel, an aluminum frame, a second, interior Lauan plywood panel, and decorative vinyl on the interior face of the wall.

Turning to FIG. 2, a recreational vehicle wall 10 from the prior art for a recreational vehicle can have a cross-sectional layered arrangement that includes an FRP skin 110 with a first side 112 and a bonding side 114, a first Lauan panel 120 with an exterior side 122 and an interior side 124, a central aluminum frame 130 with an outer side 132 and an inner side 134, a second Lauan panel 140 with an outward side 142 and an inward side 144, and a decorative vinyl layer 150 with a bonding side 152 and a decorative side 154. The first side 112 of the FRP skin 110 can form the outermost layer of the wall 100 and the decorative side 154 of the decorative vinyl layer 150 can face the interior of the recreational vehicle. In the example shown, the bonding side 114 is coupled to the exterior side 122 of the first Lauan panel 120. The interior side 124 of the first Lauan panel 120 is coupled to the outer side 132 of the aluminum frame 130. The inner side 134 of the aluminum frame 130 is coupled to the outward side 142 of the second Lauan panel 140, and the inward side 144 of the second Lauan panel 140 is coupled to the bonding side 152 of the decorative vinyl layer 150. The decorative side 154 of the decorative vinyl layer 150 faces the interior of the recreational vehicle. The first and second Lauan plywood panels (120, 140) typically have a thickness of 2 to 5 millimeters (0.08 inches to 0.2 in). The decorative vinyl layer 150 is typically about 0.1 to 1 millimeters (0.004 to 0.04 in).

Aspects of the disclosure provide more efficient wall panels for decreased heat transfer with lower weight and reduced thickness which, in the case of a recreational vehicle as well as other mobile and non-mobile structures, can optimize fuel efficiency and reduce costs of cooling the interior space. Aspects of the present disclosure, while they can be utilized in any environment, will be described herein as being utilized with respect to recreational vehicles.

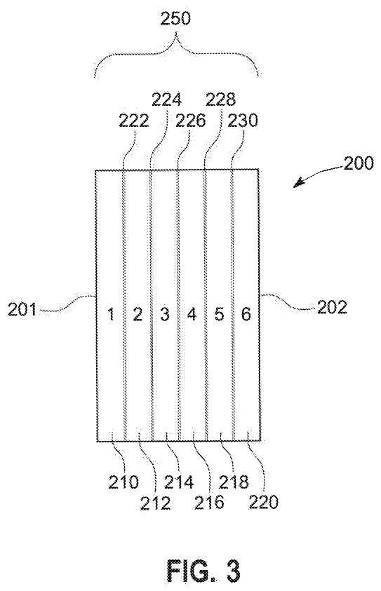

In accordance with an aspect of the disclosure, FIG. 3 shows a cross-sectional view of a multi-layered laminated paper structure 200 for use in recreational vehicles or other structures. By way of non-limiting example, the multi-layered laminated paper structure 200 can have a size of at least 48 inches by 96 inches (122 cm by 244 cm) and multiple panels can be connected together to form a panel having an area covering at least one side wall of a recreational vehicle.

The multi-layered laminated paper structure 200 comprises sequential, adjacent layers of material. The laminated paper structure 200 has a first side 201 and a second side 202. The positions determine the arrangement of plies 210, 212, 214, 216, 218, and 220. Possible ply materials include, but are not limited to, uncoated recycled chipboard (URB), kraft linerboard, kraft kaper (virgin or recycled), polyethylene terephthalate (film, coating, woven, nonwoven, metalized), polypropylene (film, coating, woven, nonwoven), aluminum foil (single ply or laminated), polypropylene foam, polyethylene foam, or heat resistant coatings having heat dissipating or reflecting properties. Each ply can have a different thickness, and for exemplary purposes, the preferable thickness of the laminated paper structure 200 with all combined layers and plies is 2 mm to 5 mm (0.08 in to 0.2 in), and preferably approximately 3 mm (0.1 in).

As shown in FIG. 3, the laminated paper structure 200 has adjacent positions 1 through 6 occupied by plies 210, 212, 214, 216, 218 and 220, which are alternately arranged with coupling layers 222, 224, 226, 228 and 230. The coupling layers 222, 224, 226, 228, and 230 comprise suitable adhesives or other coupling materials including but not limited to polymers, such as a polyethylene, polypropylene, polyethylene terephthalate, high-density or low-density forms of these polymers, and adhesive laminations such as a solvent, hotmelt, white glue, poly(vinyl alcohol) (PVOH), poly(vinyl acetates) (PVA), or waterproof glue, in various forms known in the art. High-density polyethylene (HDPE, about 0.95-0.97 g/cm³), low-density polyethylene (LDPE, about 0.91-0.94 g/cm³), and blends thereof can be included in the coupling layers 222, 224, 226, 228 and 230. These coupling layers 222, 224, 226, 228, and 230 serve to adhere adjacent plies 210, 212, 214, 216, 218, and 220. The described combination of plies 210, 212, 214, 216, 218, and 220 with coupling layers 222, 224, 226, 228, and 230 is serves to reduce the heat transfer through the laminated paper structure 200, as well as strengthen the laminated paper structure 200, and to decrease water permeability of the laminated paper structure 200.

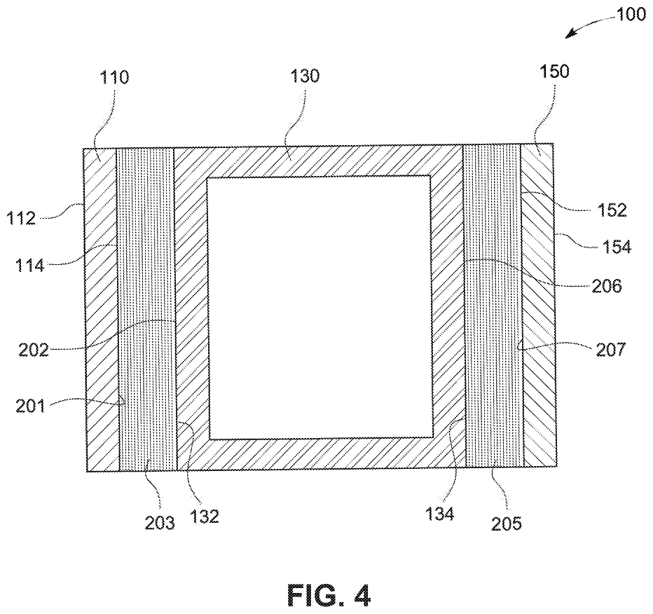

In the example of FIG. 4 it is contemplated that multiple laminated paper structures 200, as represented by a first laminated paper structure 203 and a second laminated paper structure 205, can be used to form a wall panel 100. The wall panel 100 can comprise a layered arrangement where an FRP skin 110 is coupled to or arranged adjacent to the first side 201 of the first laminated paper structure 203. The second side 202 of the laminated paper structure 200 confronts the outer side 132 of the aluminum frame 130. The second laminated paper structure 205 has a first side 206 that confronts the inner side 134 of the aluminum frame 130. The bonding side 152 of the decorative vinyl layer 150 couples to or is arranged adjacent to an outer side 207 of the second laminated paper structure 205, such that the decorative side 154 faces the interior of the walled structure or recreational vehicle. It will be understood that the compositions of the first laminated paper structure 203 and the second laminated paper structure 205 need not be identical.

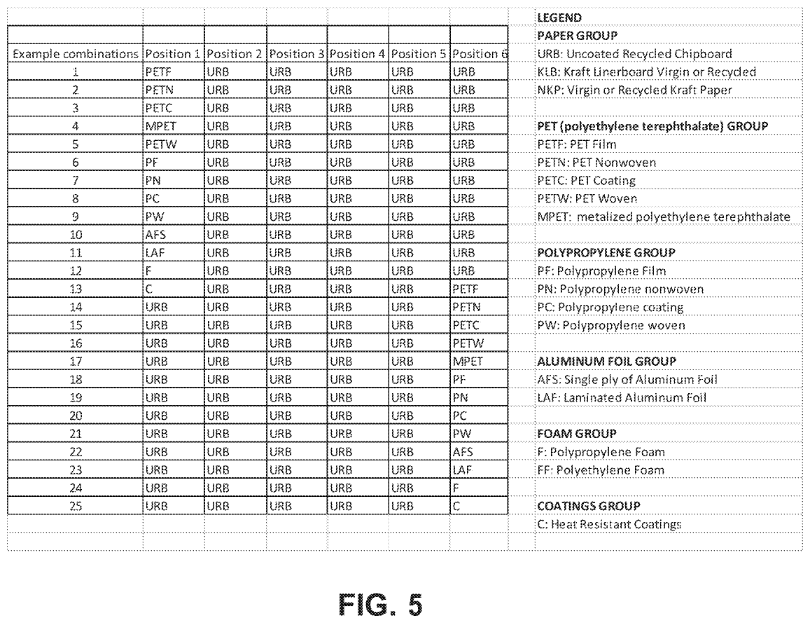

FIG. 5 illustrates 25 possible combinations of ply materials among the 6 positions in the laminated paper structure 200. The plies 210, 212, 214, 216, 218 and 220, can be chosen from but are not limited to the example materials listed in the legend of FIG. 5. The non-limiting groups of materials listed in the legend are arranged by material categories, and include but are not limited to a paper group including uncoated recycled chipboard (URB), a polyethylene terephthalate group, a polypropylene group, an aluminum foil group, a foam group, and a coatings group. The seventeen non-limiting materials listed in groups found in the legend of FIG. 5 can come in many forms including, but not limited to, woven or nonwoven materials, coatings, films, foams, or foils. The example materials have the ability to reduce, deflect or dissipate heat transfer and can be interchanged based on their heat transfer properties. For example, a polyethylene terephthalate film of 0.025 mm (0.001 in) thickness may have similar heat transfer properties as a polyethylene terephthalate nonwoven material of 1.0 mm (0.04 in) thickness.

In one example, a laminated paper structure 200 includes positions 1 through 6, where each position is occupied sequentially by plies 210, 212, 214, 216, 218 and 220. In this embodiment, position 1 is occupied by ply 210 which is a polyethylene terephthalate film. It is contemplated the polyethylene terephthalate film can have a thickness of about 0.01 mm (0.0004 in) to about 0.08 mm (0.003 in), preferably about 0.025 mm (0.001 in). Positions 2 through 6 are occupied by plies 212, 214, 216, 218 and 220 respectively, which are, in this embodiment, URB. It is contemplated the URB can have a thickness of about 0.38 mm (0.015 in) to 1.8 mm (0.07 in), preferably 0.65 mm (0.025 in). Between plies 210 and 212 is the first coupling layer 222, which is 100% low-density polyethylene (LDPE) in this embodiment. Between plies 212 and 214 can be the second coupling layer 224, which is PVOH in this case. Between plies 214 and 216 is the third coupling layer 226, which is PVOH having a minimal thickness. Between plies 216 and 218 is the fourth coupling layer 228, having a minimal thickness. Between plies 218 and 220 is the fifth coupling layer 230, which is PVOH, applied to the plies in a minimal amount necessary for bonding and having a minimal thickness. For exemplary purposes, ply 210 can have a thickness of about 0.025 mm (0.001 in), and plies 212, 214, 216, 218, and 220 can have thicknesses of about 0.65 mm (0.025 in) such that the laminated paper structure 200 shown in FIG. 3 has a finished thickness 250, which can be, for example, in the range of about 2 mm to 5 mm (0.07 in to 0.2 in), preferably about 2.7 mm (0.1 in). It will be understood that the plies and layers can all have the same or equal thicknesses, or that thicknesses can be different and vary as desired within the laminated paper structure (203, 205).

In yet another aspect of the disclosure, a coupling layer 222 that is 100% LDPE may be used to couple ply 210 to ply 212, whereas coupling layers 224, 226, 228, and 230 between plies 212, 214, 216, 218 and 220, can be 100% high-density polyethylene. Further arrangements of the plies and coupling layers among the six positions are expressed in FIG. 5.

In yet another non-limiting aspect of the disclosure, a polypropylene nonwoven material is chosen for ply 202, at position 1, having a thickness of about 1 mm (0.04 in), and URB is chosen for plies 210, 212, 214, 216 and 218 at positions 2, 3, 4, 5, and 6 respectively, each having a thickness of about 0.38 mm to 01.8 mm (0.015 to 0.070 in), preferably about 0.65 mm (0.025 in) to form the laminated paper structure 200 having an overall thickness of about 2 mm to 4 mm (about 0.07 in to 0.16 in), preferably about 3 mm (0.12 in).

In yet another aspect of the disclosure, a polypropylene nonwoven material is chosen for ply 210, at position 1, having a thickness of about 1 mm (0.04 in), and URB is chosen for ply 210 and ply 212, at positions 2 and 3, each having a thickness of about 0.8 mm to 0.9 mm (about 0.03 in to 0.04 in), preferably about 0.85 mm (0.033 in), whereby the combined laminated paper structure 200 has an overall thickness of about 2 mm (0.08 in) to 4 mm (0.16 in), preferably about 2.7 mm (0.1 in).

It is contemplated that using the materials described herein in a paper lamination process allows for continuous manufacturing at high speeds and the example materials have the ability to reduce, deflect or dissipate heat transfer and can be readily interchanged based on their heat transfer properties. Using laminated plies of paper allows for a uniform blemish-free composite, and the attributes of the laminated paper structure 200 can be selected easily by choice of component materials. Since each ply of material can have a different thickness, the subsequent material thicknesses for each ply can be chosen to achieve the desired material properties and maintaining an overall thickness of approximately 3 mm (0.12 in). Depending on the chosen raw materials, the laminated paper structure 200 may have the added advantage of being lighter than Lauan plywood, which will be advantageous to reduce user's energy costs.

Furthermore, the use of a material such as a nonwovens material can provide an advantage by allowing water to move through microgaps instead of accumulating inside the wall panel. Another advantage of materials such as foam, films, coatings, woven and nonwoven materials is that these materials can flex and move during the expansion and contraction of temperature cycles as well as reduce the stresses of motion that a recreational vehicle can undergo. Additionally, traditional water-based adhesives like polyvinyl acetate PVA or polyvinyl alcohol PVOH or adhesive blends may contain more solids and less moisture, thus reducing the propensity of temperature to affect the wall panel structure when exposed to extreme weather conditions.

It can be appreciated that the wall panels described herein can include a variety of materials as the exterior layer, the central frame and the interior layer. While illustrated with FRP skin, aluminum and decorative vinyl respectively in these positions, it should be understood that a number of profiles, shapes, or variations in materials can be utilized for these components in the spirit of the present disclosure.

It will be understood by one having ordinary skill in the art that construction of the described device and other components may not be limited to any specific material. Although the present disclosure shows one ideal embodiment using a multi-laminated paper structure as the substrate for the heat dissipating or reflecting materials, it is not meant to limit the structural materials that could be used as the substrate. For example, materials such as hardboard, oriented strand board, medium density hardboard, or composite materials including fiber-reinforced polymeric materials or Azdel, may be coupled with uncoated recycled chipboard (URB), kraft linerboard, kraft paper (virgin or recycled), polyethylene terephthalate (film, coating, woven, nonwoven, metalized), polypropylene (film, coating, woven, nonwoven), aluminum foil (single ply or laminated), polypropylene foam, polyethylene foam, or coatings, having heat resistant or reflecting properties. The thickness of the plies and the arrangement of the plies with respect to one another is not limited to the examples given here. Further, different numbers of plies may be used based on the manufacturers' material choices. Other exemplary embodiments of the device disclosed herein may be formed from a wide variety of materials, unless described otherwise herein.

To the extent not already described, the different features and structures of the various embodiments may be used in combination with each other as desired. That one feature may not be illustrated in all of the embodiments and is not meant to be construed that it may not be, but is done for brevity of description. Thus, the various features of the different embodiments may be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A multi-layered laminated paper structure for use as an RV wall comprising:
a first layer comprising one of a polyethylene terephthalate (PET), polypropylene, aluminum foil, foam or heat resistant coating; and
at least two layers comprising a ply of paper; and
a coupling layer comprising an adhesive between each of first layer and the at least two layers for adhering each of the layers together.

2. The multi-layered laminated paper structure of claim 1 wherein the ply of paper comprises one of an uncoated recycled chipboard, kraft linerboard or kraft paper.

3. The multi-layered laminated paper structure of claim 2 wherein the ply of paper comprises uncoated recycled chipboard.

4. The multi-layered laminated paper structure of claim 1 wherein the PET comprises one of a PET film, PET nonwoven material, PET woven material, PET coating or metalized polyethylene terephthalate.

5. The multi-layered laminated paper structure of claim 1 wherein the polypropylene comprises one of a polypropylene film, polypropylene nonwoven material, polypropylene woven material, or polypropylene coating.

6. The multi-layered laminated paper structure of claim 1 wherein the aluminum foil is one or a single ply or laminated aluminum foil.

7. The multi-layered laminated paper structure of claim 1 wherein the adhesive is one of a polyethylene, polypropylene, polyethylene terephthalate, poly(vinyl acetate), poly (vinyl alcohol), solvent, hotmelt, white glue, or waterproof glue.

8. The multi-layered laminated paper structure of claim 1 wherein the coupling layer between the first layer and one of the at least two layers comprises a low-density polyethylene.

9. The multi-layered laminated paper structure of claim 1 wherein the coupling layer between the at least two layers comprises a high-density polyethylene.

10. The multi-layered laminated paper structure of claim 1 wherein the first layer comprises a polypropylene nonwoven material.

11. The multi-layered laminated paper structure of claim 1 wherein each of two layers has the same thickness.

12. The multi-layered laminated paper structure of claim 1 wherein each of two layers has the different thickness.

13. A multi-layered laminated paper structure for use as an RV wall comprising:
a first layer comprising a polyethylene terephthalate film;
a second layer comprising a first ply of uncoated recycled chipboard; and
a low-density polyethylene adhesive adhering the first layer to the second layer.

14. The multi-layered laminated paper structure of claim 13 further comprising a third layer comprising a second ply of uncoated recycled chipboard and a polyvinyl alcohol adhesive for adhering the third layer to the second layer.

15. The multi-layered laminated paper structure of claim 14 further comprising a fourth layer comprising a third ply of uncoated recycled chipboard and a polyvinyl alcohol adhesive for adhering the fourth layer to the third layer.

16. The multi-layered laminated paper structure of claim 15 further comprising a fifth layer comprising a fourth ply of uncoated recycled chipboard and a polyvinyl alcohol adhesive for adhering the fifth layer to the fourth layer.

17. The multi-layered laminated paper structure of claim 16 further comprising a sixth layer comprising a fifth ply of uncoated recycled chipboard and a polyvinyl alcohol adhesive for adhering the sixth layer to the fifth layer.

18. The multi-layered laminated paper structure of claim 13 wherein the laminated paper structure has a preferred thickness of about 2 mm to 3 mm.

19. The multi-layered laminated paper structure of claim 13 wherein the laminated paper structure is blemish free.

20. The multi-layered laminated paper structure of claim 13 wherein the first layer comprises a thickness of 0.01 mm to 0.08 mm.

21. The multi-layered laminated paper structure of claim 13 wherein the second layer has a thickness of 0.38 mm to 1.8 mm (0.015 to 0.07 in).

22. A recreational vehicle comprising at least one side wall comprising:
a fiber-glass reinforced panel;
an aluminum frame;
a multi-layered laminated paper structure positioned between the fiber-glass reinforced panel and the aluminum frame; the multi-layered laminated paper structure comprising:
a first layer comprising one of a polyethylene terephthalate, polypropylene, aluminum foil, foam or heat resistant coating; and
at least two layers comprising a ply of paper; and
a coupling layer comprising an adhesive between each of first layer and the at least two layers for adhering each of the layers together.

23. The recreational vehicle of claim 22 wherein the multi-layered laminated paper structure is a panel at least 48 inches by 96 inches, or about 122 cm by 244 cm.

24. The recreational vehicle of claim 23 wherein multiple panels are connected to form a panel having an area covering the at least one side wall.

25. The recreational vehicle of claim 22, further comprising a second multi-layered laminated paper structure on an opposite side of the aluminum frame.

26. A recreational vehicle comprising at least one side wall comprising:
a fiber-glass reinforced panel;
an aluminum frame;
a heat-reflecting substrate positioned between the fiber-glass reinforced panel and the aluminum frame for reflecting heat away from the recreational vehicle.
